(19) United States
(12) Patent Application Publication
(10) Pub. No.: US 2012/0120238 A1
(43) Pub. Date: May 17, 2012

(54) TWO LAYER VIDEO MOTION DETECTION

(75) Inventors: Uri Adar, Nofit (IL); Yaron Megged, Herzeliya (IL); Israel Kasher, Raanana (IL)

(73) Assignee: Seraphim Optronics Ltd., Yokne'am Elit (IL)

(21) Appl. No.: 13/295,415

(22) Filed: Nov. 14, 2011

Related U.S. Application Data
(60) Provisional application No. 61/344,910, filed on Nov. 15, 2010.

(51) Int. Cl. H04N 7/18; G06K 9/00

(52) U.S. Cl. 348/143; 382/107; 348/E07.085

(57) ABSTRACT

A method of identifying suspicious movements in video images, comprising: examining a video stream, in a first video motion detection (VMD) stage, to identify sequences of a plurality of video frames in which the video frames together indicate a possibility of movement of an object within the video stream; initiating operation of a second VMD stage on the video stream, which includes analyzing the pixel content of frames of the video stream to identify suspect objects, responsive to an indication from the first VMD stage; and providing an indication of a suspicious movement if the second VMD resulted in an identification of movement of a suspect object.

### PRIORITY INFORMATION

The present invention claims priority to U.S. Provisional Application No. 61/344,910 which was filed on Nov. 15, 2010, making reference to same herein in its entirety.

### FIELD OF THE INVENTION

The present invention relates to surveillance systems and particularly to video motion detection systems.

### BACKGROUND OF THE INVENTION

Video Motion Detection (VMD), also known as video content analysis, is used, inter alia, in the field of surveillance, for identifying suspicious movements in a monitored area. Typically, an alarm is generated and/or images are recorded for later analysis and/or viewing by a human operator.

Various VMD methods have been developed to accommodate usage in different operating environments. Generally, a specific method is devised to operate at a specific working point, selecting a desired tradeoff between accuracy and resources required such as processing power consumption and processing time, for example.

US patent publication 2010/0013931 to Golan et al., the disclosure of which is incorporated herein by reference, describes one particular VMD method.

In some systems, raw video data is transmitted from surveillance cameras to a control unit, where the VMD is performed. This type of set up has the advantage that the sites of the surveillance cameras do not need to have processors strong enough to perform VMD with a desired accuracy. On the other hand, the transmission of large amounts of video data to the control unit, whether over cables or over a wireless connection, may require large transmission resources. Therefore, in some scenarios it is desired to have the VMD performed on site, near the camera, such that only important images need to be transmitted and/or stored.

US patent publication 2005/0078747 to Hamza et al., titled “Multi-Stage Moving Object Segmentation”, the disclosure of which is incorporated herein by reference, describes a system in which a high-speed motion detection algorithm removes still frames that do not portray motion and the remaining frames are subjected to a robust motion detection algorithm. This approach reduces the number of frames to which VMD needs to be applied, at the expense of the additional resources required to remove the still frames. Using such a multi-stage method is only worthwhile if the extra resources required for the first stage do not outweigh the gain of the second stage. Consequently, most surveillance systems use a single stage VMD.

US patent publication 2005/0036659 to Talmon et al., titled: “Method and System for Effectively Performing Event Detection in a Large Number of Concurrent Image Sequences”, the disclosure of which is incorporated herein by reference, describes a system in which local cameras acquire images and respective local encoders extract features therefrom and forward them to a central server. When required, the central server instructs one or more local encoders to transmit the images themselves, in addition to the features.

### SUMMARY OF THE INVENTION

A first aspect of the invention is directed to a method of identifying suspicious movements in video images, comprising: examining a video stream, in a first video motion detection (VMD) stage, to identify sequences of a plurality of video frames in which the video frames together indicate a possibility of movement of an object within the video stream; initiating operation of a second VMD stage on the video stream, which includes analyzing the pixel content of frames of the video stream to identify suspect objects, responsive to an indication from the first VMD stage; and providing an indication of a suspicious movement if the second VMD resulted in an identification of movement of a suspect object.

Optionally, initiating operation of the second VMD stage requires operating at least one processor not used by the first VMD stage.

In some embodiments, the first VMD stage searches for changes between consecutive frames correlated in a manner which matches directed movement.

Optionally, examining the video stream, in a first video motion detection (VMD) stage, to identify sequences of a plurality of video frames comprises examining to identify sequences of at least four frames in which the video frames together indicate a possibility of movement of an object within the video stream.

Optionally, the second VMD stage does not use any results from the first VMD method beyond the indication that it needs to operate.

Optionally, the first and second VMD stages are configured such that the second VMD method has a suspicious movement detection rate greater than 10%.

In some embodiments, the method further comprises continuously buffering the video frames and assuring they are not overwritten at least until a decision is made that they are not needed by the second stage.

A second aspect is directed to a method of identifying suspicious movements in video images, comprising: examining a video stream, in a first video motion detection (VMD) stage, to identify video frames which may show a possibility of movement of an object within them; initiating operation of a second VMD stage on the video stream, which includes analyzing the pixel content of frames of the video stream to identify suspect objects, responsive to an identification by the first VMD stage; and providing an indication of a suspicious movement if the second VMD resulted in an identification of movement of a suspect object, wherein the second VMD stage generates a background model of a surveyed area in the image only after an indication from the first stage is received.

A method of identifying suspicious movements in video images, comprising: examining a video stream, in a first video motion detection (VMD) stage, to identify video frame sequences which may show a possibility of movement of an object within them; initiating operation of a second VMD stage on the video stream, which includes analyzing the pixel content of frames of the video stream to identify suspect objects, responsive to an identification by the first VMD stage; and buffering the video frames of the video stream, such that during operation at least ten frames behind the current frame are available in the buffer, for the second stage.

Optionally, initiating operation of the second VMD stage requires operating at least one processor not used by the first VMD stage.

Optionally, examining the video stream, in the first video motion detection (VMD) stage comprises examining sequences of a plurality of video frames, to identify sequences in which the video frames together indicate a possibility of movement of an object within the video stream.

Optionally, the second VMD stage does not use any results from the first VMD method beyond the indication that it needs to operate.

In a third aspect, the present invention is directed to a surveillance unit, comprising: a video camera adapted to acquire consecutive images from a monitored area; a first processor configured to perform a first video motion detection VMD method on sequences of images acquired by the camera, in a manner which identifies sequences of images which together indicate a possibility of movement; and a second processor configured to remain in a sleep state unless a signal indicative of detection of a possibility of movement by the first processor is received, in which case the second processor performs a second VMD method on a sequence of images starting with the images for which the first processor identified movement.

Preferably, the surveillance unit comprises a memory and a controller adapted to buffer acquired images in the memory while the first VMD is running, and provide the buffered images to the second processor upon detection of a possible movement by the first processor.

Preferably the controller is adapted to store in the buffer a sufficient length of video images, such that the second processor can be provided at least 0.5 seconds of images before a first detection of a possibility of movement.

Optionally, the second processor is adapted to use the images from before the first detection of a possibility of movement in generating a background model to which subsequent images are compared.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1 is a schematic illustration of a two layer VMD in accordance with an embodiment of the invention;

FIG. 2 is a schematic illustration of a two layer VMD coupled with a video recorder, in accordance with an embodiment of the invention;

FIG. 3 is a schematic illustration of a video frame;

FIG. 4a shows a schematic illustration of a 4 lines (each comprising two rows of pixels) at a region of a frame for a scenario where movement is detected, and FIG. 4b shows the equivalent time domain, and

FIG. 5a is a schematic illustration of 4 lines (each comprising two rows of pixels) at a region of a frame for a scenario where movement is not detected, where FIG. 5b shows the equivalent time domain.

### DETAILED DESCRIPTION OF EMBODIMENTS

An aspect of some embodiments of the present invention relates to a multi-stage video motion detection system in which a first stage determines which images are to be analyzed by a second stage, and the second stage searches for suspicious objects in raw video data of these images. In accordance with this aspect, the determination of the first stage as to whether images are to be analyzed by the second stage is based on a comparison of sequences of images, including two, three or even at least four images, with a previous image or with a base model.

It will be appreciated that having the first stage consider sequences of images rather than a single image, makes the first stage more complex. However, in accordance with embodiments of the present invention, this extra complexity has been found to be outweighed by the gain resulting from operating the second stage less frequently.

In some embodiments of the invention, the first stage invokes the second stage only when the changes in a sequence of images are correlated in a manner which matches directed movement.

Optionally, the second stage does not use results from the first stage, beyond the indication that it needs to operate. While this may be considered wasteful in requiring extra effort in the second stage, it allows the first stage to be selected without any constraints on compatibility to the second stage.

In some embodiments of the invention, the VMD system is configured to buffer video frames whilst they are being examined in the first stage, in order that the frames can be used by the second stage when actuated.

An aspect of some embodiments of the present invention relates to a multi-stage video motion detection system in which the second stage generates a background model of the surveyed area only after an indication that additional analysis is required, is received from the first stage. While generating the background model only when additional analysis is required increases the time and complexity of the second stage, it has been found to reduce the processing power required to generate the model at times when additional analysis is not required.

In some embodiments of the invention, the performance of the second stage requires initiating operation of one or more processors or other hardware units which are kept in a low power (or even a no-power) consumption state until the second stage is operated. Optionally, the first and second stages use different hardware units, such that the hardware used by the first stage is not used by the second stage and vice versa. Alternatively, the second stage uses a processor which performs the first stage and in addition uses an extra processor which is shut down when in the first stage.

Optionally, the first stage is configured to transfer to the second VMD stage only a small fraction of the video frames taken, such that the percentage of movement identifications by the second stage is substantial (e.g., at least 10% or even at least 20%).

In some embodiments of the invention, the power utilization of the second VMD stage is at least five times or even at least ten times greater than the power utilization of the first stage.

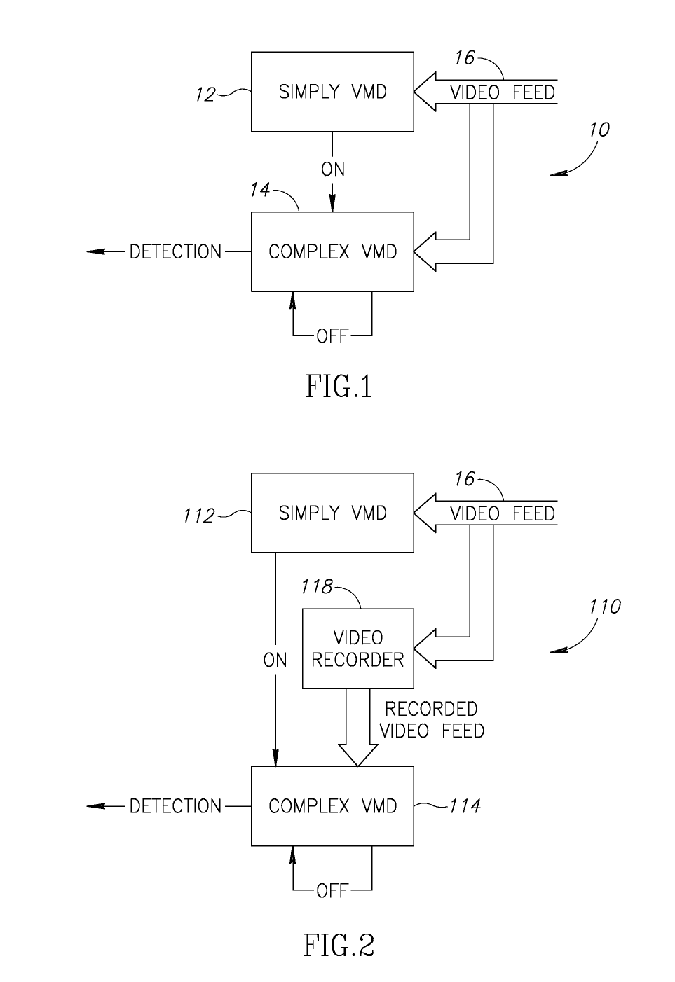

With reference to FIG. 1, in some embodiments of the invention, a two layer VMD scheme 10 is used to analyze a video stream, such that the basic layer is a simple VMD 12 that runs most of the time and the upper level is a complex VMD 14 that runs only when the simple VMD 12 detects anything. When the simple VMD 12 detects anything suspicious, (Pre-Detection), the operation of the complex VMD 14 is initiated. The complex VMD 14 analyzes the video feed 16 and determines if this is a true motion detection (based on its algorithm and rules) or if the simple VMD 12 detection is a false positive.

If the detection of motion by the simple VMD 12 is determined by the complex VMD 14 to be a true detection, the two layer VMD scheme 10 reports it as such. If the complex VMD 14 determines that the simple VMD 12 had made a false detection, the complex VMD 14 stops running and the simple VMD 12 continues to run on its own, thereby reducing power consumption.

With reference to FIG. 2, in a second embodiment of a two layer VMD scheme 110, mutatis mutandis, a video recorder 118, working in a cyclic manner, may be used to record the video feed 16 before and/or after a Pre-detection by the simple VMD 112. This may be required if the complex VMD 114 has a substantial activation time or learning time and the video stream received from the feed 16 during that time is needed. Optionally, the video recorder 118 has sufficient storage capacity, such that when the complex VMD 114 is operated, the recorder 118 has not yet overwritten the frames causing the simple VMD 112 to invoke the complex VMD 114. Possibly, the video recorder 118 has sufficient storage capacity, such that when the complex VMD 114 is operated, the recorder 118 has not yet overwritten at least a predetermined number of seconds (e.g., 3, 5, 10) worth of video frames before the frames causing the simple VMD 112 to invoke the activation of the complex VMD 114. It is noted that in various embodiments the storage capacity of the video recorder 118 may be relatively small, sufficient only to store the frames required by the complex VMD 114 for its analysis, or may be relatively large, allowing storage of as much as an hour or even several hours worth of footage.

In an exemplary embodiment of the invention, the complex VMD 14 (114) is realized by a NICE® content analysis algorithm running on one or more of a Texas Instruments® DSP, DM642 or ObjectVideo, Intrusion Detector product, running on Intel x86®. The simple VMD 12 (112) optionally operates on a low power DSP, such as Texas Instruments® C5510, that runs an image comparison algorithm to detect changes.

### Simple VMD Algorithm

In some embodiments of the invention, the Simple VMD 12 (112) receives consecutive video frames. It analyzes them one by one (all of them or only some of them, depending on the expected object velocity).

Optionally, instead of reviewing the entire frame, only a few vertical and/or horizontal regions from each frame selected are analyzed, where each region is consists of just a few lines (rows or columns). Thus, the analysis is limited to a relatively small number of pixels and can be realized on a low-performance computing platform. Furthermore, it will be appreciated that limiting the pixel count reduces power consumption related to communication lines, memory and other peripherals.

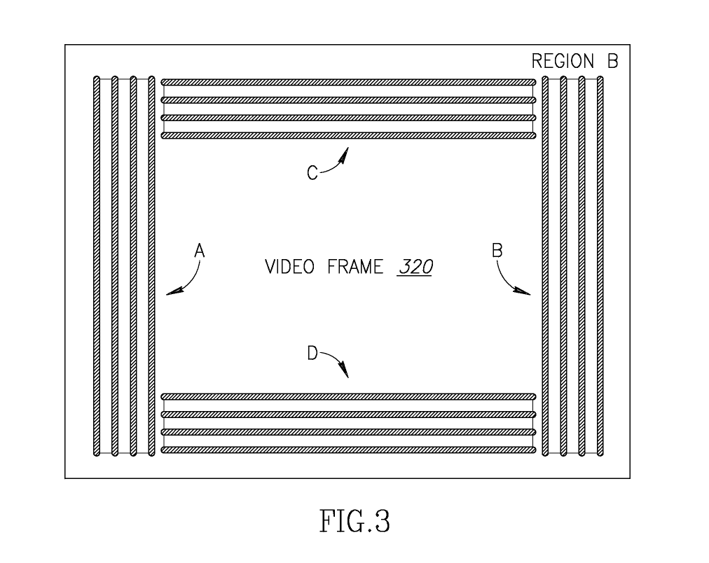

With reference to FIG. 3, a video frame 320 with 4 detection regions is shown. There are two vertical detection regions, (A and B) and two horizontal detection regions (C and D). Each region (A, B, C, D) includes 4 parallel lines.
Each line width may be 1, 2 or 4 pixels. Using more than 1 pixel may facilitate averaging out random signals and artifacts (noise). The pixels from each line selected are analyzed and a temporal change as compared to some threshold value is searched for. Numerous pixels that show a change together are joined together to form a “cluster”. The algorithm searches for clusters appearing in all or part of the lines of a region in around the same location in an orderly fashion with a fairly constant time difference.

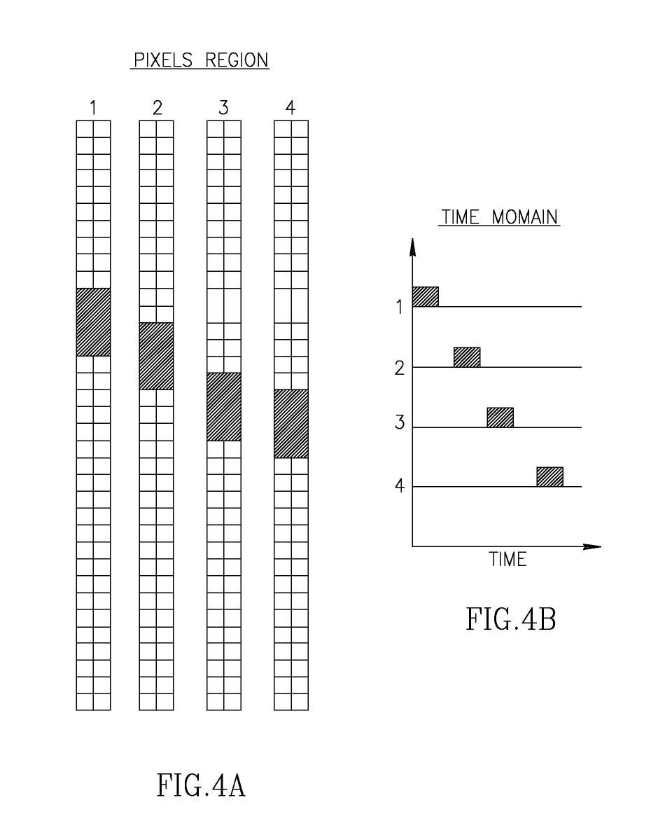

With reference to FIG. 4a, an example of four lines that form a region is schematically depicted, wherein each of the lines consists of two rows of pixels. A black square indicates a pixel that changed. Each group of black pixels is considered as being a cluster. It will be noted that all the clusters are depicted at about the same height. In FIG. 4b, the time at which the pixel clusters in each of the lines 1 to 4 are detected is shown. It is evident from this typical example, that the clusters appear in an orderly manner (one by one). The coherence in position and time suggests that a physical object has crossed the field-of-view from left to right heading downwards and the algorithm will issue a “detection” signal.

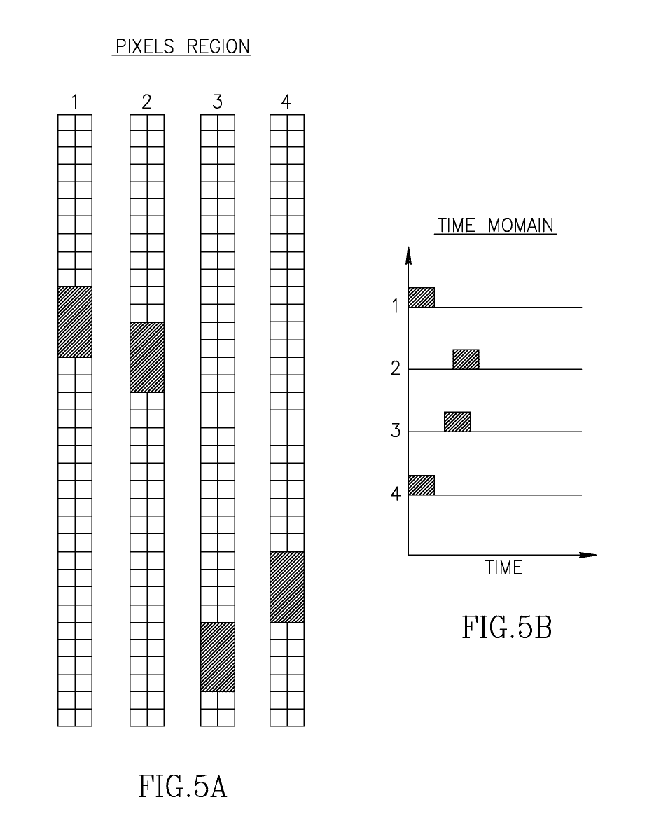

In FIG. 5, an event that won't be counted as a “detection” is shown. The reason that no event is detected is because the clusters don't show up in about the same vertical position. Furthermore, their temporal order of appearance is not sequential.

Algorithms based on this approach may be configured for various scenarios such as number of lines. Their position, length and separation (in pixels), allowed temporal deviation between crossing adjacent lines, allowed vertical distance between crossing positions, allowed deviation in cluster size, and the like.

It should be understood that features and/or steps described with respect to one embodiment may sometimes be used with other embodiments and that not all embodiments of the invention have all of the features and/or steps shown in a particular figure or described with respect to one of the specific embodiments.

It is noted that some of the above described embodiments may describe the best mode contemplated by the inventors and therefore may include structure, acts or details of structures and acts that may not be essential to the invention and which are described as examples. Structure and acts described herein are replaceable by equivalents which perform the same function, even if the structure or acts are different, as known in the art. Variations of embodiments described will occur to persons of the art. Therefore, the scope of the invention is limited only by the elements and limitations as used in the claims, wherein the terms “comprise,” “include,” “have” and their conjugates, shall mean, when used in the claims, “including but not necessarily limited to.”

We claim:

1. A method of identifying suspicious movements in video images, comprising:
examining a video stream, in a first video motion detection (VMD) stage, to identify sequences of a plurality of video frames in which the video frames together indicate a possibility of movement of an object within the video stream;
initiating operation of a second VMD stage on the video stream, which includes analyzing the pixel content of frames of the video stream to identify suspect objects, responsive to an indication from the first VMD stage; and
providing an indication of a suspicious movement if the second VMD resulted in an identification of movement of a suspect object.

2. The method of claim 1, wherein initiating operation of the second VMD stage requires operating at least one processor not used by the first VMD stage.

3. The method of claim 1, wherein the first VMD stage searches for changes between consecutive frames correlated in a manner which matches directed movement.

4. The method of claim 1, wherein examining the video stream, in a first video motion detection (VMD) stage, to identify sequences of a plurality of video frames comprises examining to identify sequences of at least four frames in which the video frames together indicate a possibility of movement of an object within the video stream.

5. The method of claim 1, wherein the second VMD stage does not use any results from the first VMD method beyond the indication that it needs to operate.

6. The method of claim 1, wherein the first and second VMD stages are configured such that the second VMD method has a suspicious movement detection rate greater than 10%.

7. The method of claim 1, comprising continuously buffering the video frames and assuring they are not overwritten at least until a decision is made that they are not needed by the second stage.

8. A method of identifying suspicious movements in video images, comprising:
examining a video stream, in a first video motion detection (VMD) stage, to identify video frames which may show a possibility of movement of an object within them;
initiating operation of a second VMD stage on the video stream, which includes analyzing the pixel content of frames of the video stream to identify suspect objects, responsive to an identification by the first VMD stage; and
providing an indication of a suspicious movement if the second VMD resulted in an identification of movement of a suspect object,
wherein the second VMD stage generates a background model of a surveyed area in the image only after an indication from the first stage is received.

9. A method of identifying suspicious movements in video images, comprising:
examining a video stream, in a first video motion detection (VMD) stage, to identify video frame sequences which may show a possibility of movement of an object within them;
initiating operation of a second VMD stage on the video stream, which includes analyzing the pixel content of frames of the video stream to identify suspect objects, responsive to an identification by the first VMD stage; and
buffering the video frames of the video stream, such that during operation at least ten frames behind the current frame are available in the buffer, for the second stage.

10. The method of claim 9, wherein initiating operation of the second VMD stage requires operating at least one processor not used by the first VMD stage.

11. The method of claim 9, wherein examining the video stream, in the first video motion detection (VMD) stage comprises examining sequences of a plurality of video frames, to identify sequences in which the video frames together indicate a possibility of movement of an object within the video stream.

12. The method of claim 9, wherein the second VMD stage does not use any results from the first VMD method beyond the indication that it needs to operate.

13. A surveillance unit, comprising:
a video camera adapted to acquire consecutive images from a monitored area;
a first processor configured to perform a first video motion detection VMD method on sequences of images acquired by the camera, in a manner which identifies sequences of images which together indicate a possibility of movement; and
a second processor configured to remain in a sleep state unless a signal indicative of detection of a possibility of movement by the first processor is received, in which case the second processor performs a second VMD method on a sequence of images starting with the images for which the first processor identified movement.

14. The surveillance unit of claim 13, comprising a memory and a controller adapted to buffer acquired images in the memory while the first VMD is running, and provide the buffered images to the second processor upon detection of a possible movement by the first processor.

15. The surveillance unit of claim 14, wherein the controller is adapted to store in the buffer a sufficient length of video images, such that the second processor can be provided at least 0.5 seconds of images before a first detection of a possibility of movement.

16. The surveillance unit of claim 15, wherein the second processor is adapted to use the images from before the first detection of a possibility of movement in generating a background model to which subsequent images are compared.
